(19) United States
(12) Patent Application Publication
(10) Pub. No.: US 2013/0109451 A1
(43) Pub. Date: May 2, 2013

(54) GAME SYSTEM, CONTROL METHOD THEREFOR, AND A STORAGE MEDIUM STORING A COMPUTER PROGRAM

(71) Applicants: Takashi Hamano, Minato-ku (JP); Nobuhiro Onodera, Minato-ku (JP)

(72) Inventors: Takashi Hamano, Minato-ku (JP); Nobuhiro Onodera, Minato-ku (JP)

(21) Appl. No.: 13/809,868

(22) PCT Filed: Jul. 14, 2011
(86) PCT No.: PCT/JP2011/066126

§ 371 Date: Jan. 11, 2013

(30) Foreign Application Priority Data
Jul. 15, 2010 (JP) 2010-161100

(51) Int. Cl. A63F 13/04

(52) U.S. Cl. CPC A63F 13/04
USPC 463/5; 463/32

(57) ABSTRACT

The disclosed game system is provided with a large monitor (4), two gun-shaped controllers (5), and a small monitor (7) provided on each controller (5). Said game system: creates a virtual three-dimensional game space (GW) for playing a game; generates two-dimensional images related to a prescribed extent of a part of the virtual three-dimensional space (GW) in accordance with prescribed conditions; outputs said two-dimensional images to the large monitor (4); generates other two-dimensional images related to a fixed extent of a part of the virtual three-dimensional game space (GW) in accordance with the directions that the muzzles (5j) of the gun-shaped controllers (5) are pointing, said directions not depending on the prescribed conditions used in the determination of the extent outputted to the large monitor (4); and outputs said other two-dimensional images to the small monitors (7) on the controllers (5).

### TECHNICAL FIELD

The present invention relates to a game system using a virtual three-dimensional (3D) space, a control method therefor, and a computer program.

### BACKGROUND ART

Games, in which a two-dimensional (2D) image is generated based on a virtual 3D space used for the progress of a game or the like and the 2D image is used as a game image, have been known (for example, see Patent Literature 1).

Patent Literature 1: Japanese Patent Application Laid-Open No. 2002-251626.

### SUMMARY OF INVENTION

### Technical Problem

In the game discussed in Patent Literature 1, a predetermined range of a virtual 3D space is generated as a 2D image according to a predetermined condition. Then, the generated 2D image is output to the display device as a game image. However, in this game, a range used as a game image is limited to a predetermined range, and there is a limitation to production of realistic sensation.

In this regard, an object of the present invention is to provide a game system, a control method therefor, and a computer program, which are capable of improving realistic sensation on a virtual 3D space for the progress of a game.

### Solution to Problem

A game system of the present invention comprises: at least two display devices; a space constructing device adapted and configured to construct a virtual three-dimensional (3D) space to cause a game to progress; a first image output device adapted and configured to generate a two-dimensional (2D) image related to a predetermined range of a part of the virtual 3D space according to a predetermined condition, and output the 2D image to one display device; and a second image output device adapted and configured to generate a 2D image related to a predetermined range of a part of the virtual 3D space according to a specific condition that does not depend on the predetermined condition, and output the 2D image to the other display device.

According to the present invention, the 2D image is generated with respect to on not only the predetermined range of the virtual 3D space according to the predetermined condition but also the predetermined range according to the specific condition, and the 2D images are output to the separate display devices. Thus, the virtual 3D space can be expressed using a plurality of display devices. Further, since the specific condition does not depend on the predetermined condition, the predetermined range includes a different range that does not overlap the predetermined range at all, a range which is opposite or adjacent to the predetermined range, and a range that does not relate to the predetermined range as well as the range overlapping the predetermined range. Thus, the range of the virtual 3D space that can be generated as the 2D image can be extended up to the range according to the specific condition. Accordingly, different ranges of the virtual 3D space can be expressed using the plurality of display devices, and thus realistic sensation on the virtual 3D space to cause the game to progress can be improved.

In an embodiment of the game system of the present invention, a detecting device adapted and configured to detect a player's action may be further provided, and wherein the second image output device may decide the predetermined range according to a detection result of the detecting device, using the detection result as the specific condition. In this case, the predetermined range output as the 2D image can be decided such that the player's request is reflected, and thus realistic sensation on the virtual 3D space can be further improved.

In the embodiment in which the detecting device is provided, an input device adapted and configured to receive the player's operation may be further provided, wherein the input device may be configured to be movable, and the detecting device may be provided in the input device and detect an operation of the input device as the player's action. In this case, it is possible to decide the predetermined range of the virtual 3D space generated as the 2D image based on the operation of the input device.

In the embodiment in which the input device is provided, the other display device to which the second image output device outputs the 2D image may be provided in the input device. In this case, the display device can be operated in conjunction with an operation of deciding the 2D image of the predetermined range to be output to the display device. Further, the input device is not limited to a specific device. For example, a gun-type controller having a muzzle may be used as the input device, and the second image output device may decide the predetermined range according to a direction in which the muzzle faces.

A control method of the present invention is a control method of controlling a computer incorporated in a game system comprising at least two display devices, and wherein the control method of controlling the computer comprises the steps: a space constructing step that constructs a virtual three-dimensional (3D) space to cause a game to progress; a first image output step that generates a two-dimensional (2D) image related to a predetermined range of a part of the virtual 3D space according to a predetermined condition, and outputs the 2D image to one display device; and a second image output step that generates a 2D image related to a predetermined range of a part of the virtual 3D space according to a specific condition that does not depend on the predetermined condition, and outputs the 2D image to the other display device.

Further, a computer program for an game system of the present invention is a computer program for a game system comprising at least two display devices, and wherein the computer program is configured so as to cause a computer which is incorporated in the game system to serve as: a space constructing device adapted and configured to construct a virtual three-dimensional (3D) space to cause a game to progress; a first image output device adapted and configured to generate a two-dimensional (2D) image related to a predetermined range of a part of the virtual 3D space according to a predetermined condition, and output the 2D image to one display device; and a second image output device adapted and configured to generate a 2D image related to a predetermined range of a part of the virtual 3D space according to a specific condition that does not depend on the predetermined condition, and output the 2D image to the other display device. By executing the control method or the computer program of the present invention, it is possible to realize the game system of the present invention.

### Advantageous Effects of Invention

As described above, according to the present invention, it is possible to improve realistic sensation on a virtual 3D space for the progress of a game.

### BRIEF DESCRIPTION OF DRAWINGS

FIG. 1 is a diagram schematically illustrating an external appearance of a game machine to which a game system according to an embodiment of the present invention is applied;

FIG. 2 is a diagram schematically illustrating the inside of a dedicated housing included in a game machine;

FIG. 3 is a schematic diagram illustrating a control system of a game machine;

FIG. 4 is a perspective view of a gun-type controller seen from a right front;

FIG. 5 is a diagram schematically illustrating a movable range of a gun-type controller;

FIG. 6 is a diagram for describing an example of a relation between game screens;

FIG. 7 is a diagram illustrating an example of a virtual 3D game space;

FIG. 8 is a flowchart illustrating an example of a range deciding process routine;

FIG. 9 is a diagram illustrating an example of a photographing range of a first virtual camera;

FIG. 10 is a diagram illustrating an example of a photographing range of a third virtual camera; and

FIG. 11 is a functional block diagram of an image processing unit.

### DESCRIPTION OF EMBODIMENTS

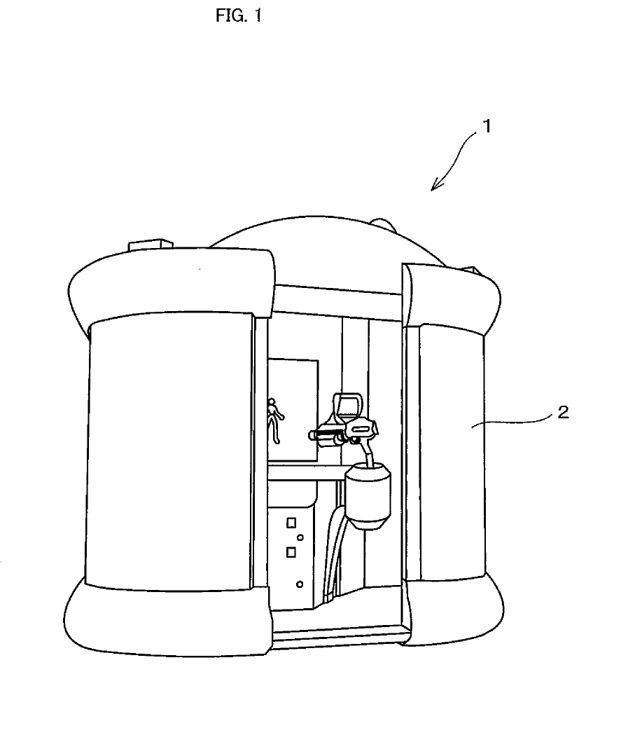

Hereinafter, a game machine to which a game system according to an embodiment of the present invention is applied will be described with reference to the drawings. Incidentally, the game machine of the present invention provides a game of an action type in which a player explores a virtual game space and carries out a predetermined mission by operating a character (which may be hereinafter referred to as a “player character”) set as an operation target. FIG. 1 is a diagram schematically illustrating an external appearance of a game machine 1. As illustrated in FIG. 1, the game machine 1 includes a dedicated housing 2 of a jug type. An elliptical space is formed inside the dedicated housing 2, and the player plays a game inside the dedicated housing 2.

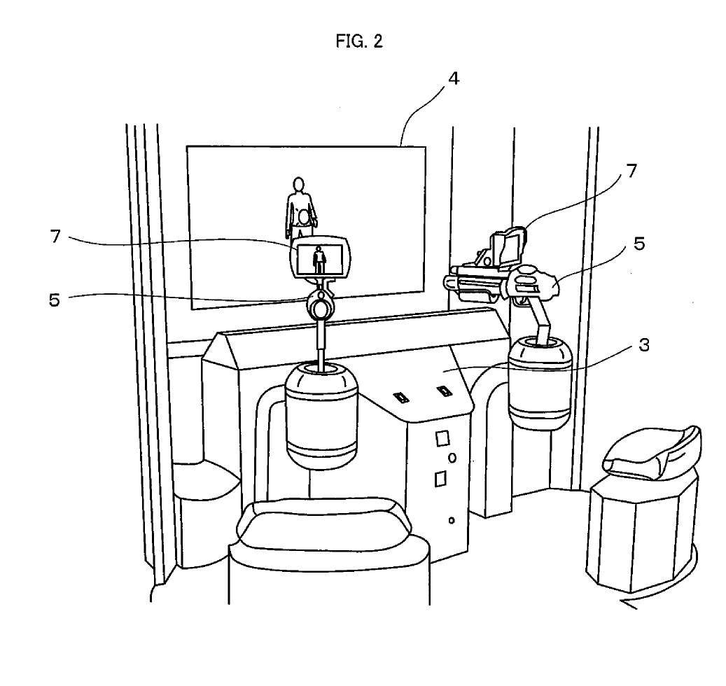

FIG. 2 is a diagram schematically illustrating the inside of the dedicated housing 2. As illustrated in FIG. 2, a game machine main body 3, a large monitor 4 (for example, a liquid crystal display device (LCD)) serving as a main display device, and two gun-type controllers 5 serving as an input device that symbolizes a weapon given to the player are provided inside the dedicated housing 2. In addition, a small monitor 7 serving as another display device is provided on an upper portion of each gun-type controller 5. Incidentally, although not illustrated in the drawings, the game machine main body 3 may be provided with various kinds of input devices and output devices disposed in a typical game machine for business such as a button to make a selection or a decision, a power switch, and a volume operating switch.

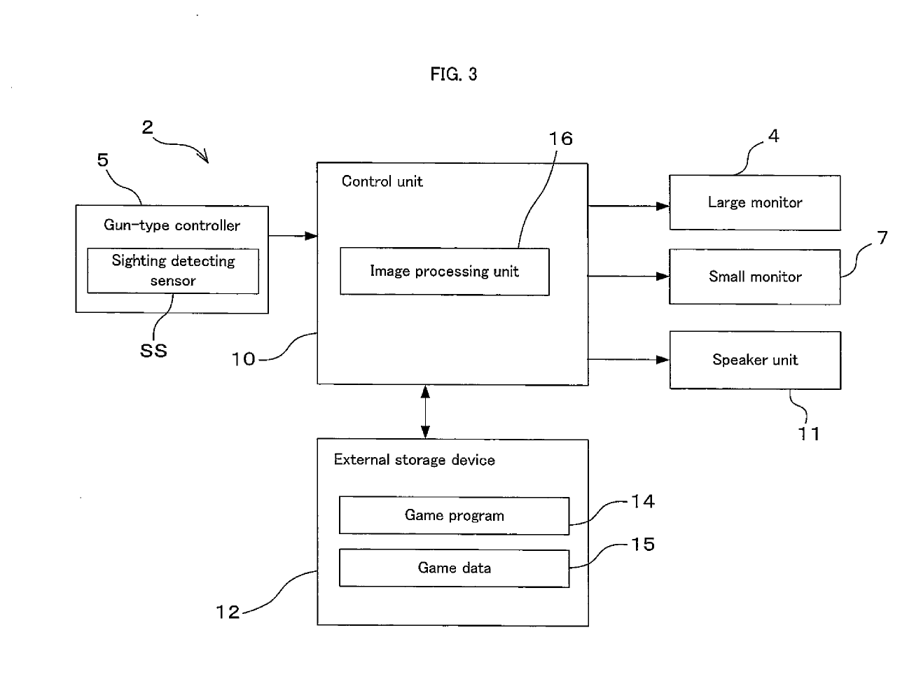

Various kinds of devices are stored inside the game machine main body 3. FIG. 3 is a schematic diagram illustrating a control system of the game machine 1 including some of various kinds of devices in the game machine main body 3. As illustrated in FIG. 3, a control unit 10, a speaker unit 11, and an external storage device 12 are included as various kinds of devices in the game machine main body 3. The control unit 10 is configured as a computer unit in which a microprocessor is combined with peripheral devices such as a main storage device (a random access memory (RAM) or a read only memory (ROM)) or the like, which are necessary for an operation of the microprocessor. The large monitor 4, each small monitor 7, the gun-type controller 5, the speaker unit 11, and the external storage device 12 are connected to the control unit 10. Besides, various kinds of peripheral devices can be connected to the control unit 10, but illustration thereof is not provided.

The external storage device 12 is a storage device including a non-volatile storage medium such as a magnetic storage medium, an optical storage medium, an electrically erasable programmable read-only memory (EEPROM). In addition to an operating system to implement basic control of the control unit 10, a game program 14 serving as application software to execute a game according to a predetermined procedure, and a game data 15 appropriately referred to by the game program 14 are recorded in the external storage device 12. As the control unit 10 reads and executes the game program 14, various kinds of logical devices necessary for execution of a game are generated in the control unit 10. An image processing unit 16 is formed in the control unit 10 as one of the logical devices. The image processing unit 16 executes various kinds of calculation processes necessary for generating an image to be displayed on the large monitor 4 and each small monitor 7. The details of the image processing unit 16 will be described later.

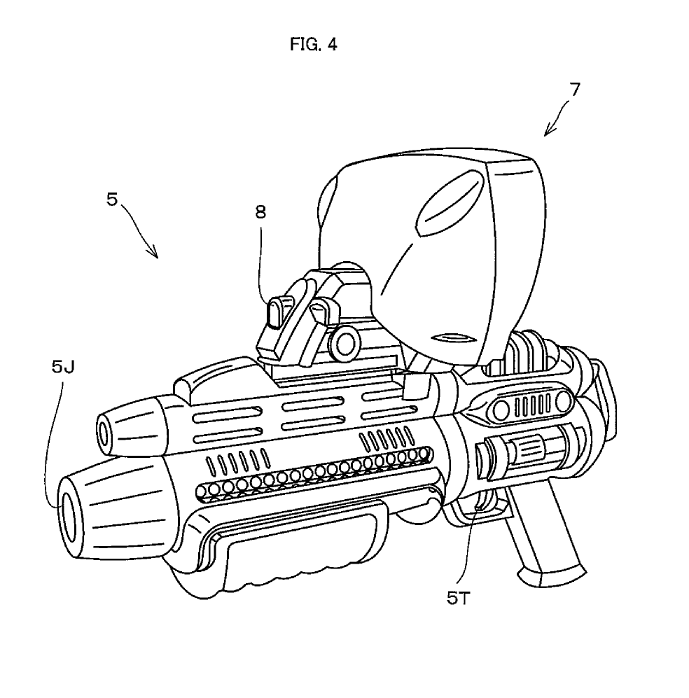

The gun-type controller 5 is provided with a sighting detecting sensor SS serving as a detecting device. FIG. 4 is a perspective view of the gun-type controller 5 seen from the right front. The sighting detecting sensor SS detects a direction in which a muzzle 5j faces. Various kinds of known sensors may be used as the sighting detecting sensor SS. In the present embodiment, as an example of the sighting detecting sensor SS, as will be described later, a biaxial sensor using a lever, which detects a moving direction of the gun-type controller 5, is installed inside a platform to which the gun-type controller 5 is attached. However, the present invention is not limited to this embodiment, and various kinds of sensors such as a gyroscopic sensor, a geomagnetic sensor, or an acceleration sensor may be used as the sighting detecting sensor SS.

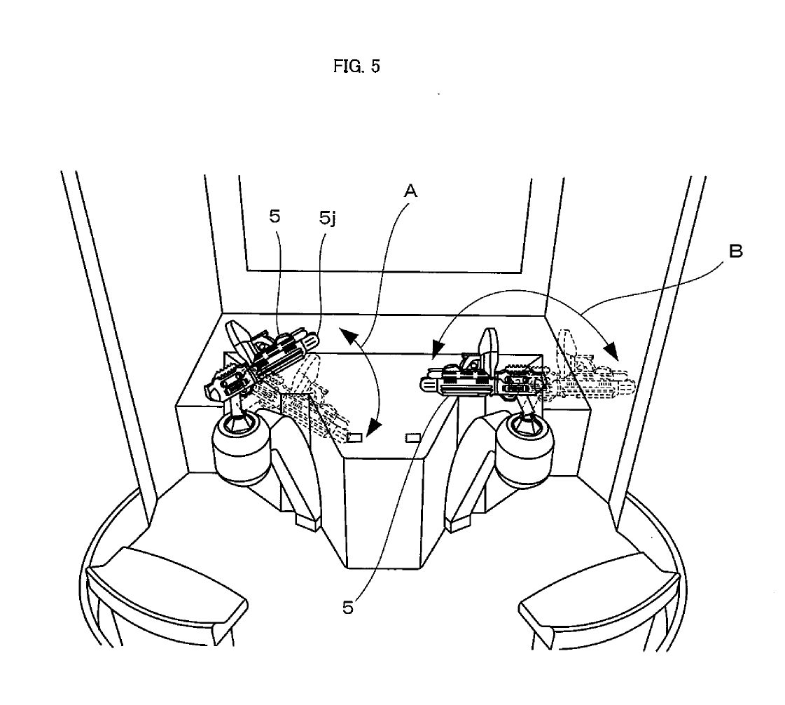

FIG. 5 is a diagram schematically illustrating the movable range of the gun-type controller 5. Both of two arrows A and B of FIG. 5 represent the movable range of the gun-type controller 5. As illustrated in FIG. 5, the gun-type controller 5 is configured so as to be able to move in both in a horizontal direction and a vertical direction. A range in the vertical direction indicated by the arrow A from below to above the large monitor 4 and a range in the horizontal direction indicated by the arrow B from one side to the other side of the dedicated housing 2 are set as the movable range. The sighting detecting sensor SS detects a direction in which the muzzle 5j faces, which serves as a specific condition, in the movable range indicated by the arrows A and B. Incidentally, in FIG. 5, for convenience of description, the movable range is illustrated for each gun-type controller 5, but in each actual gun-type controller 5, the movable range is set in both the corresponding vertical direction and the horizontal direction.

In addition, in the gun-type controller 5, a small camera 8 serving as a photographing device is provided in front of the small monitor 7 as illustrated in FIG. 4. Each gun-type controller 5 is provided with a trigger unit 5T serving as an operating unit that receives the player's operation. Each gun-type controller 5 outputs a signal corresponding to an operation of each trigger unit 5T to the control unit 10.

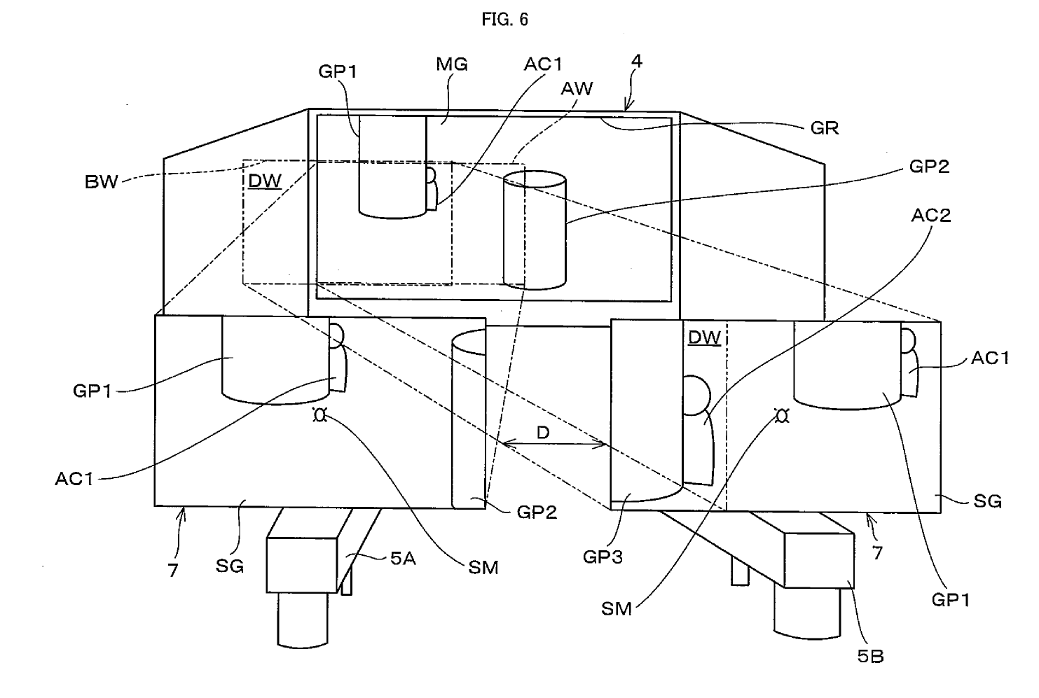

Next, an example of the game screen will be described. FIG. 6 illustrates an example of a game screen for describing a relation between game screens displayed on the large monitor 4 and each small monitor 7. A main image MG representing a form of a virtual 3D game space such as an indoor place set as a place in which a player character moves is displayed on the game screen GR. A form of a part of a wide space set as the virtual 3D game space is displayed in the main image MG. And, various kinds of objects such as poles GP1 and GP2 or a character AC1 arranged on the virtual 3D game space are present in the main image MG. The player character may not be displayed. The enemy character AC1 is operated by the control unit 10 of the game machine 1. Alternatively, a character AC operated by a player of another game machine connected with the game machine 1 via a network may be present in the main image MG.

Meanwhile, the sub image SG representing a form of a range set as a field-of-view range of the player character in the virtual 3D game space is displayed on each small monitor 7. Further, the field-of-view range is decided depending on the direction in which the muzzle 5j faces. Specifically, a predetermined range in the virtual 3D game space corresponding to the direction in which the muzzle 5j faces is set as the field-of-view range. A range smaller than a range corresponding to the main image MG is set as the predetermined range. Further, for example, by setting a range corresponding to an initial position of the muzzle 5j in the virtual 3D game space as an initial field-of-view range, the range corresponding to the direction in which the muzzle 5j faces is decided based on a position change from the initial position of the muzzle 5j. As an example of the initial position, the position at which a plane forming the muzzle 5j is parallel to the large monitor 4 may be set to a range overlapping the main image MG as the initial field-of-view range corresponding to this initial position. A sighting marker SM representing the position that the muzzle 5j faces is displayed on the center of each sub image SG. Further, various kinds of objects are also present in each sub image, similarly to the main image MG.

The example of FIG. 6 illustrates the field-of-view range when the muzzle 5j of the first gun-type controller 5A arranged on the left side is positioned at the initial position. An alternate long and short dash line of FIG. 6 represents a predetermined range AW corresponding to the field-of-view range of the first gun-type controller 5A. As illustrated in FIG. 6, a form of a range corresponding to a range of a part of the main image MG in the virtual 3D game space is displayed on the small monitor 7 of the first gun-type controller 5A as the field-of-view range. Further, the predetermined range AW falls within the range shown in the main image MG.

Meanwhile, the muzzle 5j of the second gun-type controller 5B arranged on the right side of FIG. 6 faces in a direction in which the position thereof changes from the initial position, and a range shifted from the range shown in the main image MG in the left direction by a width D serves as the predetermined range. An alternate long and two short dashes line of FIG. 6 represents a predetermined range BW corresponding to the field-of-view range of the second gun-type controller 5B. Thus, not only the range which is in common with the main image MG in the virtual 3D game space but also the form of the range shifted to the left side from the range corresponding to the main image MG by the width D is displayed on the small monitor 7 of the second gun-type controller 5B. Thus, a form of a game space corresponding to the shift range (the shift range of the predetermined range BW corresponding to the width D) DW at the left side which is not displayed in the main image MG is displayed on the small monitor 7 of the second gun-type controller 5B. In the example of FIG. 6, the pole GP3 present at the left side of the main image MG and the enemy character AC2 positioning so as to hide behind it are displayed on the small monitor 7 of the second gun-type controller 5B. As described above, the player causes the game to progress with reference to the range of the virtual 3D game space displayed in the main image MG while considering the virtual 3D game space of the range which is not displayed in the main image MG through each the small monitor 7. Incidentally, various kinds of other information such as a gauge are appropriately displayed on the large monitor 4 and each small monitor 7.

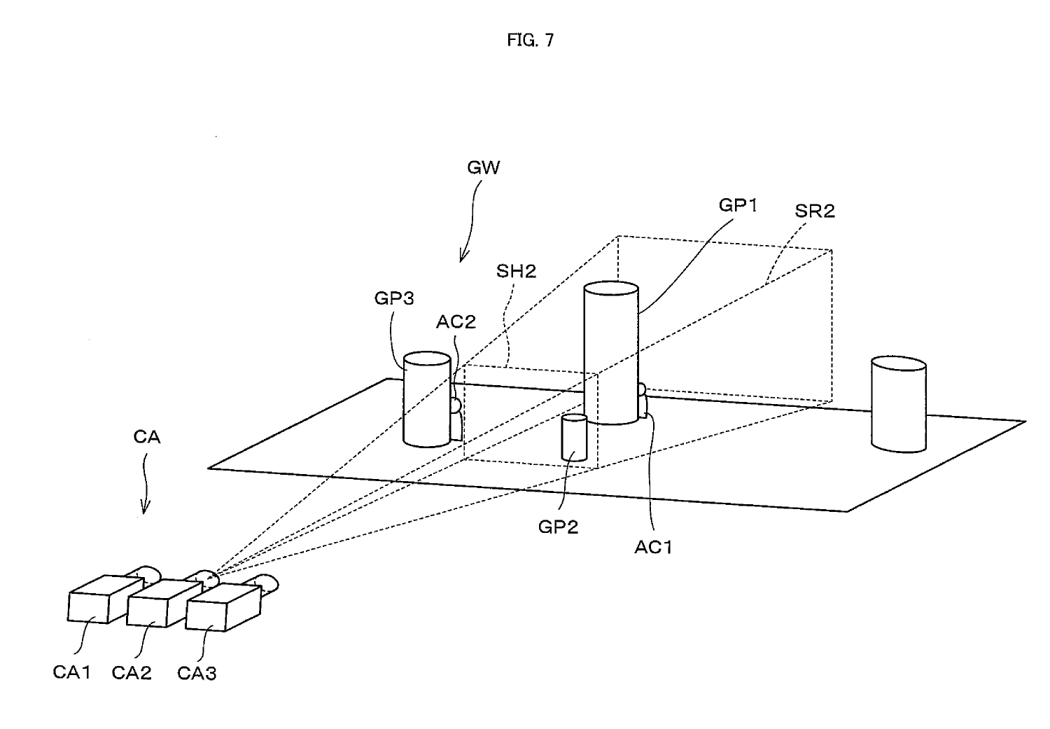

Next, a process executed by the image processing unit 16 (see the control unit 10 of FIG. 3) will be described. In order to cause the main image MG and each sub image SG to be displayed on each of the monitors 4 and 7, the image processing unit 16 performs rendering on each of the images MG and SG according to a procedure of a so-called 3D computer graphics process. Next, the rendering method will be described. FIG. 7 is a diagram illustrating an example of the virtual 3D game space which is logically generated on a memory of the control unit 10 by the image processing unit 16. A virtual 3D game space GW is one in which a game space displayed in each of the images MG and SG is expressed as a 3D model. Various kinds of objects such as the poles GP1 and GP2 or the character AC which may be displayed in each of the images MG and SG are arranged on the virtual 3D game space GW.

Three virtual cameras CA are set in the virtual 3D game space GW. In an example of FIG. 7, the virtual cameras CA are arranged in the order of a first virtual camera CA1 provided to generate an image for the small monitor 7 of the first gun-type controller 5A, a second virtual camera CA2 provided to generate an image for the large monitor 4, and a third virtual camera CA3 provided to generate an image for the small monitor 7 of the second gun-type controller 5B from the left of FIG. 7. A distance between the first virtual camera CA1 and the third virtual camera CA3 is set so as to correspond to a distance between the first gun-type controller 5A and the second gun-type controller 5B. Further, the second virtual camera CA2 has a visual angle larger than the other virtual cameras CA1 and CA3 so that the second virtual camera CA2 can photograph the range larger than the first virtual camera CA1 and the third virtual camera CA3. Alternatively, the second virtual camera CA2 having the same visual angle as the other cameras CA1 and CA3 may be arranged at the rear side (at the position apart from the virtual 3D game space GW) further than the other cameras CA1 and CA3.

The positions of each object and the position of each camera CA in the virtual 3D game space GW are defined by 3D coordinates according to a tri-axial orthogonal coordinate system (world coordinates) of X, Y, and Z axes. The photographing ranges of the cameras CA1, CA2, and CA3 are set based on a visual angle, the position of a point of view, and a photographing direction. Furthermore, for each virtual camera CA, a field of view plane to project a space within the photographing range is set at the position apart from each camera CA in the photographing direction by a predetermined distance. Thus, the range present at the position far from the position to which the field-of-view plane is set is set as the photographing range of each virtual camera CA.

The position or the photographing direction that satisfies a predetermined condition corresponding to the progress of a game is set in advance as the position of the point of view or the photographing direction of the second virtual camera CA2. Thus, in the second virtual camera CA2, a space of a part of the 3D game space GW is set as a photographing range SR2 based on the visual angle, the position of the point of view, and the photographing direction which are set according to a predetermined condition. Further, a field-of-view plane SH2 to project a space within the photographing range SR2 is set at the position apart from the second virtual camera CA2 by a predetermined distance. In the example of FIG. 7, a space corresponding to the main image MG of FIG. 6, that is, a space including the two poles GP1 and GP2, and the enemy character AC1 is set as the photographing range SR2.

Meanwhile, the point of view or the photographing direction of the other virtual cameras CA1 and CA3 are decided by the control unit 10 based on the direction of the muzzle 5j of each gun-type controller 5 corresponding to each of the cameras CA1 and CA3. For example, an initial photographing direction or the like corresponding to the initial position of the gun-type controller 5 is set, and the point of view or the photographing direction is decided based on a change on the initial photographing direction or the like. The direction in which both of the photographing ranges of the first virtual camera CA1 and the third virtual camera CA3 are included in the photographing range SR2 may be used as an example of the initial photographing direction corresponding to the initial position.

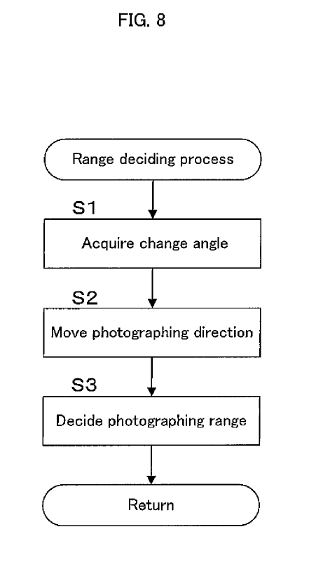

FIG. 8 is a flowchart illustrating an example of a range deciding process routine that the image processing unit 16 executes with a predetermined period in order to decide the photographing ranges of the first virtual camera CA1 and the third virtual camera CA3. As illustrated in FIG. 8, first, in step S1, the image processing unit 16 acquires change angles of the gun-type controllers 5A and 5B corresponding to the first virtual camera CA1 and the third virtual camera CA3 based on a signal output from the sighting detecting sensor SS (see FIG. 3). As the change angles, the change angles from the initial positions of the gun-type controllers 5A and 5B are acquired in the horizontal direction and the vertical direction. Next, in step S2, the photographing directions of the corresponding virtual cameras CA1 and CA3 are moved from the initial photographing directions in the horizontal direction and the vertical direction by the change angles acquired in step S1. At this time, the movement is made such that a predetermined distance between each camera CA1 or CA3 and each field-of-view plane SH1 or SH3 is kept. Next, in step S3, the ranges over each field-of-view plane SH1 or SH3 in the photographing directions after movement are decided as the photographing ranges, and then the current routine ends. As a result, the photographing ranges of the cameras CA1 and CA3 can be set to the range of the virtual 3D game space GW corresponding to the operations of the gun-type controllers 5.

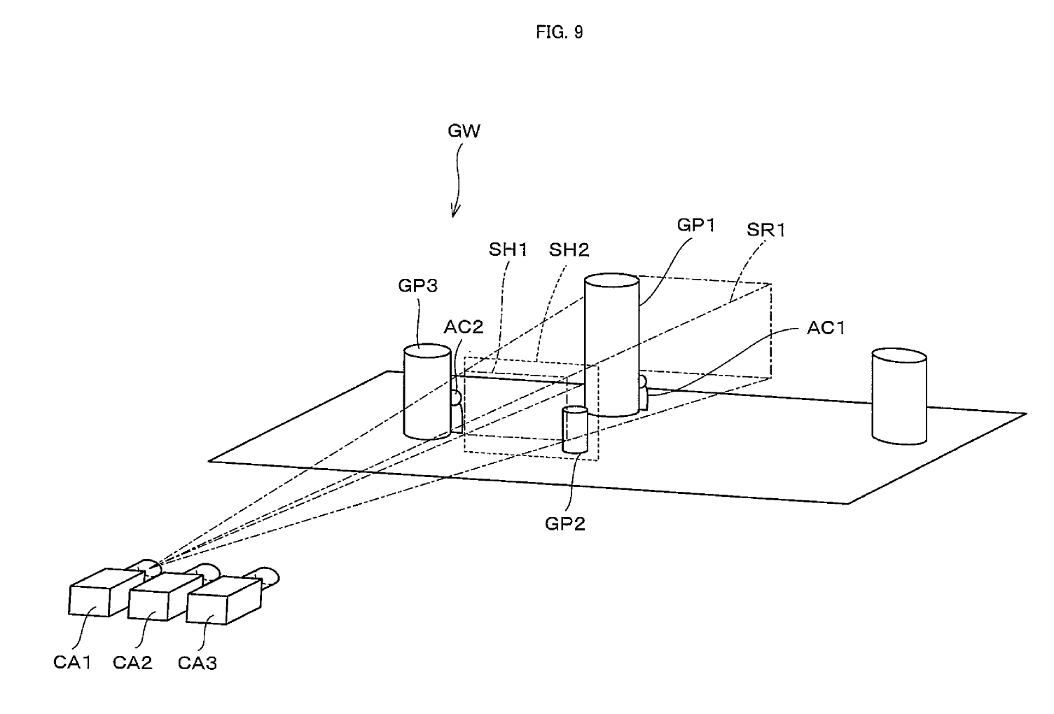

Further, FIG. 9 is a diagram illustrating an example of the photographing range SR1 of the first virtual camera CA1. FIG. 9 illustrates an example in which the gun-type controller 5 is positioned at the initial position corresponding to the first gun-type controller 5A of the example of FIG. 6, and the initial photographing direction or the like is set as the photographing direction or the like. The field-of-view plane SH1 to project the space within the photographing range SR1 is set at the position apart from the first virtual camera CA1 by a predetermined distance. As illustrated in FIG. 9, the field-of-view plane SH1 of the first virtual camera CA1 indicated by an alternate long and short dash line is included in the field-of-view plane SH2 of the second virtual camera CA2 indicated by a dashed line. Further, in the example of FIG. 9, the space corresponding to the sub image SG displayed on the small monitor 7 of the first gun-type controller 5A of FIG. 6, that is, the space including the lower portion of the pole GP1, the enemy character AC1 hiding behind there, and a part of the pole GP2 are set as the photographing range SR1.

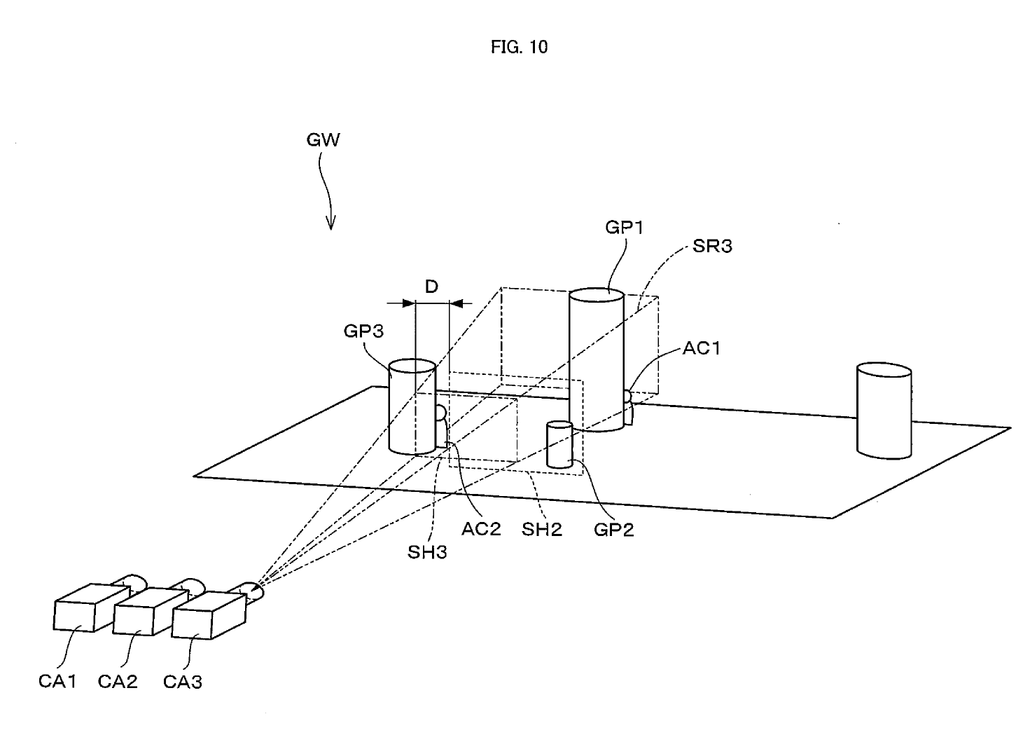

Meanwhile, FIG. 10 is a diagram illustrating an example of the photographing range SR3 of the third virtual camera CA3. The example of FIG. 10 illustrates the photographing direction or the like when the gun-type controller 5 is positioned at the position corresponding to the second gun-type controller 5B of the example of FIG. 6. In this example, the field-of-view plane SH3 set at the position apart from the third virtual camera CA3 by a predetermined distance is shifted from the field-of-view plane SH2 of the second virtual camera CA2 by the width D in the left direction. The field-of-view plane SH3 is indicated by the alternate long and two short dashed line, and the field-of-view plane SH2 is indicated by the dashed line. As a result, the space of the virtual 3D game space which is not included in the photographing range SR2 is included in the photographing range SR3. The photographing range SR3 of this example corresponds to the space corresponding to the sub image SG displayed on the small monitor 7 of the second gun-type controller 5B of FIG. 6, that is, the space including the pole GP3 and the enemy character AC2 hiding behind the pole GP3 in addition to the lower portion of the pole GP1 and the enemy character AC1 hiding behind the pole GP1.

The image processing unit 16 controls the point-of-view position and the photographing direction of each virtual camera CA, and virtually photographs a space of a part of the 3D virtual game space GW through each camera CA. Further, the image processing unit 16 calculates a 2D image in which the photographed virtual 3D game space GW is projected on the field-of-view planes SH1, SH2, and SH3 of the virtual cameras CA1, CA2, and CA3. Then, the image processing unit 16 renders the obtained 2D image on the frame memory, and outputs an image signal corresponding to the rendered image data to the monitors 4 and 7 with a predetermined period. As a result, the main image MG is displayed on the large monitor 4, and the sub image SG corresponding to each gun-type controller 5 is displayed on each small monitor 7.

Incidentally, a display element such as a gauge to be superimposed on the main image MG or the sub image SG is rendered such that the display element is appropriately superimposed on a frame memory. A series of processes such as an arrangement of various kinds of objects in the virtual 3D game space GW, control of each virtual camera CA according to the point of view and the photographing direction of each camera CA, and photographing by each virtual camera CA are performed using a known process such as a modeling process or a rendering process in a 3D computer graphics process.

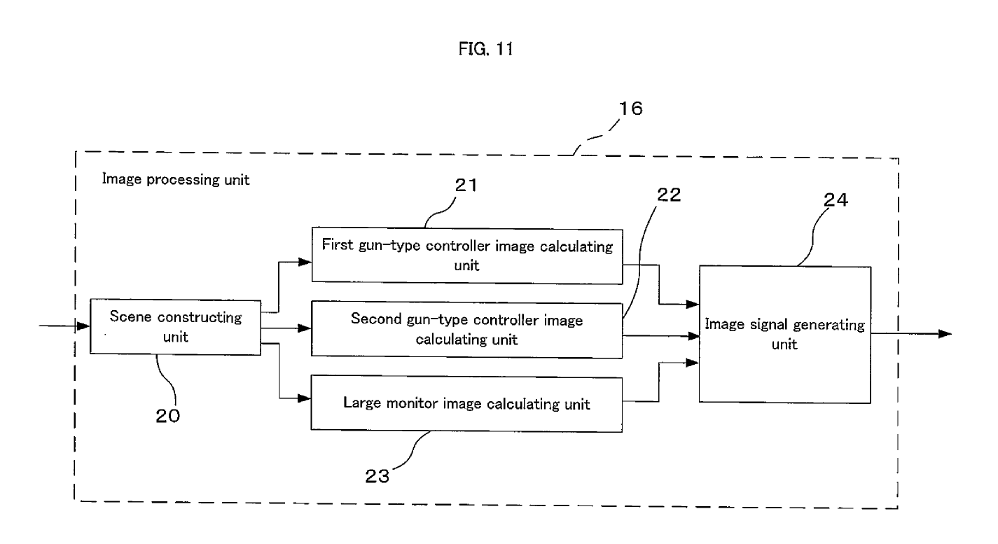

Next, a configuration of the image processing unit 16 to generate the main image MG and each sub image SG through the above-described method will be described. FIG. 11 is a functional block diagram of the image processing unit 16. As illustrated in FIG. 11, the image processing unit 16 is provided with a scene constructing unit 20, a first gun-type controller image calculating unit 21, a second gun-type controller image calculating unit 22, a large monitor image calculating unit 23, and an image signal generating unit 24.

The scene constructing unit 20 arranges various kinds of objects in the virtual 3D game space GW. At this time, the scene constructing unit 20 arranges various kinds of objects in the whole space of the virtual 3D game space GW corresponding to the movable range of the gun-type controller 5 such that the virtual 3D game space GW is constructed in the whole space corresponding to the movable range of the gun-type controller 5. Further, the scene constructing unit 20 arranges the virtual cameras CA1, CA2, and CA3 in the virtual 3D game space GW according to the point of view and the photographing direction.

The first gun-type controller image calculating unit 21 photographs the virtual 3D game space GW constructed by the scene constructing unit 20 through the first virtual camera CA1, and executes a calculation necessary to render a 2D image of the photographed space. The second gun-type controller image calculating unit 22 photographs the virtual 3D game space GW constructed by the scene constructing unit 20 through the third virtual camera CA3, and executes a calculation necessary to render a 2D image of the photographed space. Further, the large monitor image calculating unit 23 photographs the virtual 3D game space GW constructed by the scene constructing unit 20 through the second virtual camera CA2, and executes a calculation necessary to render a 2D image of the photographed space. The image signal generating unit 24 converts image data rendered by the image calculating units 21, 22, and 23 into a predetermined image signal, outputs image data rendered by the first gun-type controller image calculating unit 21 to the small monitor 7 of the first gun-type controller 5A, outputs image data rendered by the second gun-type controller image calculating unit 22 to the small monitor 7 of the second gun-type controller 5B, and outputs image data rendered by the large monitor image calculating unit 23 to the large monitor 4.

As described above, according to the game machine of this embodiment, the virtual 3D game space GW set as a place in which the player character moves or the like is constructed up to the range corresponding to the movable range of each gun-type controller 5 as well as the range displayed on the large monitor 4. Further, in the game machine 1, in addition to the large monitor 4, each gun-type controller 5 is also provided with the small monitor 7. Thus, the form of the virtual 3D game space GW can be displayed on not only the large monitor 4 but also the small monitor 7 of each controller 5. Further, since the player can turn each gun-type controller 5 in any direction, the form of any space required by the player from the virtual 3D game space can be displayed on each small monitor 7 regardless of the range displayed on the large monitor 4. Thus, the range that the player can simultaneously use in the virtual 3D game space GW can be extended up to the movable range of each gun-type controller 5. Accordingly, since the form of any range of the virtual 3D game space GW corresponding to the direction of each gun-type controller 5 can be displayed on each small monitor 7, realistic sensation of the player on the virtual 3D game space GW can be improved. Further, as the player's realistic sensation is improved, amusement of a game can be improved. In addition, by arranging a bonus object or the like in the space of the virtual 3D game space GW which is not the range displayed on the large monitor 4 but can be arbitrarily designated by the player as a display target, this space can be used as an option of a game. Through this use, the development of the game can be diversified, and thus amusement of a game can be further improved.

In the above embodiment, the control unit 10 functions as a space constructing device through the scene constructing unit 20 of the image processing unit 16, and as a first image output device and a second image output device through the image calculating units 21, 22, and 23, and the image signal generating unit 24, respectively.

The present invention is not limited to the above embodiment and may be implemented in an appropriate embodiment. In the above embodiment, an operation of the gun-type controller is used as the specific condition, but the present invention is not limited to this embodiment. For example, a direction in which the player's line of sight faces may be used as the specific condition. Thus, in the above embodiment, an operation of the input device is detected by using the gyroscopic sensor or the like as an example of the detecting device, but a target to be detected by the detecting device is not limited to this operation. Thus, any device that can detect the player's action may be used as the detecting device. The player's line of sight may be detected using the known line-of-sight detecting sensor as an example of the detecting device that detects the player's action. Further, as an example of the line-of-sight detecting sensor, there may be used a sensor of a type that receives infrared light irradiated toward an observer (player) from a plurality of places around an observation target (the large monitor 4 or the like) through a light receiving unit installed at an observer side, and detects a direction in which the light receiving unit faces based on a light reception state. Alternatively, a camera may be used as another example of the detecting device. As an example of an embodiment in which a camera is used as the detecting device, the player's action such as a direction of the muzzle of the gun-type controller may be detected by processing an image photographed by the small camera 8 installed in the gun-type controller, an image photographed by a camera installed around the player, or the like, and the action may be used as the specific condition.

Further, the specific condition is not limited to the embodiment using the player's action as described above. Various conditions may be employed as the specific condition unless the specific condition does not depend on a predetermined condition used to decide a predetermined range displayed on the large monitor 4. For example, the progress of a game, an option of a game, or a level of a player may be used as the specific condition, and a predetermined range of the virtual 3D game space displayed on the small monitor may be decided according to these conditions. Further, the small monitor 7 is not limited to the embodiment in which the small monitor 7 is installed in the input device, and for example, the small monitor 7 may be installed at a fixed position near the input device. Further, in the above embodiment, the gun-type controller imitating a gun is used as the input device, but the present invention is not limited to this embodiment, and, for example, various input devices such as an input device imitating a bow may be used as the input device.

1. A game system comprising:
at least two display devices;
a space constructing device adapted and configured to construct a virtual three-dimensional (3D) space to cause a game to progress;
a first image output device adapted and configured to generate a two-dimensional (2D) image related to a predetermined range of a part of the virtual 3D space according to a predetermined condition, and output the 2D image to one display device; and
a second image output device adapted and configured to generate a 2D image related to a predetermined range of a part of the virtual 3D space according to a specific condition that does not depend on the predetermined condition, and output the 2D image to the other display device.

2. The game system according to claim 1, further comprising a detecting device adapted and configured to detect a player's action, and wherein the second image output device decides the predetermined range according to a detection result of the detecting device, using the detection result as the specific condition.

3. The game system according to claim 2, further comprising an input device adapted and configured to receive the player's operation, wherein
the input device is configured to be movable, and
the detecting device is provided in the input device and detect an operation of the input device as the player's action.

4. The game system according to claim 3, wherein the other display device to which the second image output device outputs the 2D image is provided in the input device.

5. The game system according to claim 3, wherein a gun-type controller having a muzzle is used as the input device, and
the second image output device decides the predetermined range according to a direction in which the muzzle faces.

6. A control method of controlling a computer incorporated in a game system comprising at least two display devices, and wherein the control method of controlling the computer comprises the steps:
a space constructing step that constructs a virtual three-dimensional (3D) space to cause a game to progress;
a first image output step that generates a two-dimensional (2D) image related to a predetermined range of a part of the virtual 3D space according to a predetermined condition, and outputs the 2D image to one display device; and
a second image output step that generates a 2D image related to a predetermined range of a part of the virtual 3D space according to a specific condition that does not depend on the predetermined condition, and outputs the 2D image to the other display device.

7. A non-transitory computer readable storage medium storing a computer program for a game system comprising at least two display devices, and wherein the computer program is configured so as to cause a computer which is incorporated in the game system to serve as:
a space constructing device adapted and configured to construct a virtual three-dimensional (3D) space to cause a game to progress;
a first image output device adapted and configured to generate a two-dimensional (2D) image related to a predetermined range of a part of the virtual 3D space according to a predetermined condition, and output the 2D image to one display device; and
a second image output device adapted and configured to generate a 2D image related to a predetermined range of a part of the virtual 3D space according to a specific condition that does not depend on the predetermined condition, and output the 2D image to the other display device.
